(19) United States
(12) Patent Application Publication
(10) Pub. No.: US 2025/0122749 A1
(43) Pub. Date: Apr. 17, 2025

(54) SMART MOTOR-DRIVE MECHANISM FOR MULTI-POINT SLAM LOCK

(71) Applicant: BLUSAFE IOT TECHNOLOGY (NINGBO) CO., LTD, Ningbo (CN)

(72) Inventor: Li DONG, Ningbo (CN)

(73) Assignee: BLUSAFE IOT TECHNOLOGY (NINGBO) CO., LTD, Ningbo (CN)

(21) Appl. No.: 18/379,152

(22) Filed: Oct. 11, 2023

(51) Int. Cl. E05B 47/00

(52) U.S. Cl. CPC E05B 47/0012; E05B 2047/0017; E05B 2047/0025; E05B 2047/0026; E05B 2047/0058

(57) ABSTRACT

A smart motor-drive mechanism for multi-point slam lock includes an outer panel, an inner unit and an operating cylinder assembly arranged between the inner and outer units. The inner unit includes a battery holder and a motor. The outer side of the inner unit has a thumb turn matched with the motor through a blade receiver. A control mechanism in the inner unit is connected with the motor. The operating cylinder assembly includes a cylinder body and a cylinder drive bar assembly on the cylinder body. The blade receiver is matched and connected with the cylinder drive bar assembly. The smart motor-drive mechanism can achieve one-click unlocking and locking by arranging the motor on the operating cylinder assembly and controlling the motor by the button to drive the operating cam to rotate, thereby controlling the retraction or extension of the latch bolt, and is simple and convenient in use.

### TECHNICAL FIELD

The present invention relates to a motor-drive mechanism designed to fully deadlock and fully unlock multi-point slam (Automatic Throw) locks using a directly input security code, fingerprint recognition or activation from a mobile device via a secure App.

### BACKGROUND

Multi-Point Slam Lock door locks (MPSDL) are used in many neighbourhoods and homes. The main locking points are sprung and use a compression device to throw them into the door frame plates when the door is fully closed. The locking points individually deadlock but the main drive mechanism requires a further turn of the key to fully deadlock.

To gain entry, a traditional key operation is required to fully unlock the (MPSDL) and withdraw the latch. The key is also required to complete the final deadlock.

Smart locking systems are gaining in popularity, giving keyless entry and exit and remote locking and unlocking of standard type multi-point locks. In recent years, most of the major lock manufacturers have introduced (MPSDL) to their product ranges.

There are currently no Smart motor drive operating mechanisms designed specifically for (MPSDL) systems, as current smart products are designed to lock either after the handle lever has been manually thrown (lever lift MPL) or by two full turns of the drive cylinder to fully throw the MPL locking points (key wind MPL).

### SUMMARY

The present invention provides a smart motor-drive mechanism for multi-point slam lock which can achieve one-click unlocking and one-click locking.

A technical solution adopted to solve the above technical problem by the present invention is as follows:

A smart motor-drive mechanism for multi-point slam lock, comprising an outer panel, an inner unit and an operating cylinder assembly arranged between the outer unit and the inner unit, wherein the inner unit is provided with a battery holder and a motor, the outer side of the inner unit is provided with a thumb turn matched with the motor through a blade receiver, a control mechanism connected with the motor is arranged in the inner unit, the operating cylinder assembly comprises a cylinder body and a cylinder drive bar assembly arranged on the cylinder body, and the blade receiver is matched and connected with the cylinder drive bar assembly.

Wherein the cylinder body is provided with a penetrating lock hole, the top of the cylinder body is provided with an operating cam slot extending downwards from the lock hole, an operating cam is arranged in the operating cam slot, the operating cam comprises a third mating hole and a concave part of operating cam arranged on the side wall of the third mating hole, a first driving head and a clutch operating part are arranged in sequence in the operating cam from left to right, the axle center of the first driving head is provided with a first mating hole, the outer side of the first driving head is provided with a first engaging tongue, the axle center of the clutch operating part is provided with a second mating hole, the side wall of the clutch operating part is provided with a second engaging tongue, the end of the clutch operating part is provided with a mating groove, the outer sides of the first driving head and the clutch operating part are matched with the third mating hole, and the concave part of operating cam is matched with the first engaging tongue or the second engaging tongue, so as to control the extension or retraction of the latch bolt by driving the operating cam to rotate through the first driving head and the clutch operating part.

Wherein one side of the cylinder hole near the outer unit is provided with a key barrel, a slot for inserting a key is arranged in the key barrel, and one side of the cylinder hole near the inner unit is provided with a connecting shaft, a spring and a telescopic head in sequence; and the spring is sleeved on the telescopic head, the telescopic head comprises a connecting shaft matched with the first mating hole and the second mating hole, and the end of the connecting shaft is provided with a an end cap.

Wherein the cylinder drive bar assembly comprises a cylinder drive bar and an internally hollow circular cavity, and the cylinder drive bar is matched and connected with the blade receiver.

Wherein the spring is arranged in the circular cavity, one end of the spring is abutted against the side wall of the circular cavity, and the other end of the spring is abutted against the side wall of the first driving head and forces the first driving head and the clutch operating part to move away from the circular cavity.

Wherein the outer unit is provided with a cipher disk, a locking button and a bell button.

Wherein a lock and unlock switch is arranged below the thumb turn on the inner side of the inner unit, and the lock and unlock switch is provided with an unlocking button and a locking button.

Wherein a battery set is accommodated in the battery holder, and the battery set supplies power to the motor; and the cipher disk, the locking button and the lock and unlock switch are connected with the control mechanism and the motor in sequence.

Wherein the motor is provided with a fourth mating hole matched with the blade receiver, the inner side of the fourth mating hole is provided with a driving disk, and the motor drives the blade receiver to rotate through the driving disk when operating.

Compared with the prior art, smart motor-drive mechanism for multi-point slam lock of the present invention can achieve one-click unlocking and one-click locking by arranging the motor on the operating cylinder assembly and controlling the motor by the button to drive the operating cam to rotate so as to control the retraction or extension of the latch bolt, and is simple in structure and convenient in use. The present invention has the advantage that unlocking and locking can be realized by means of motor stalling so as to perfectly match with the lock body that is purely driven by the key to lock/unlock at different opening angles.

### DESCRIPTION OF DRAWINGS

FIG. 1 is a three-dimensional schematic diagram of a smart motor-drive mechanism for multi-point slam lock of the present invention.

FIG. 2 is an exploded schematic diagram of a smart motor-drive mechanism for multi-point slam lock of the present invention.

FIG. 3 is a local structural schematic diagram of a smart motor-drive mechanism for multi-point slam lock of the present invention.

FIG. 4 is a sectional view of a smart motor-drive mechanism for multi-point slam lock of the present invention.

FIG. 5 is a structural schematic diagram of a motor of a smart motor-drive mechanism for multi-point slam lock of the present invention.

FIG. 6 is an exploded schematic diagram of an operating cylinder assembly of a smart motor-drive mechanism for multi-point slam lock of the present invention.

### DETAILED DESCRIPTION

The present invention is further described below in detail in combination with the drawings and embodiments.

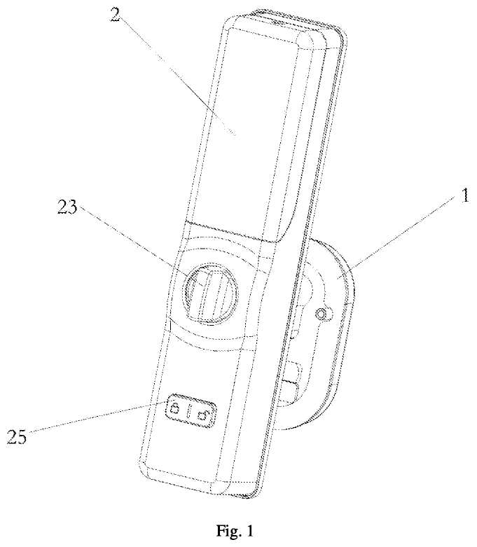

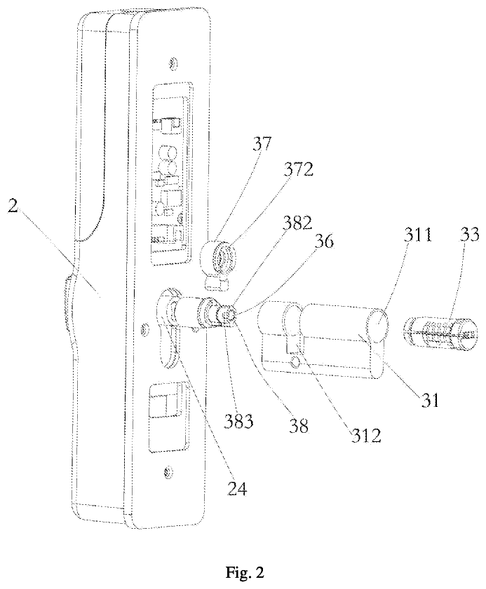

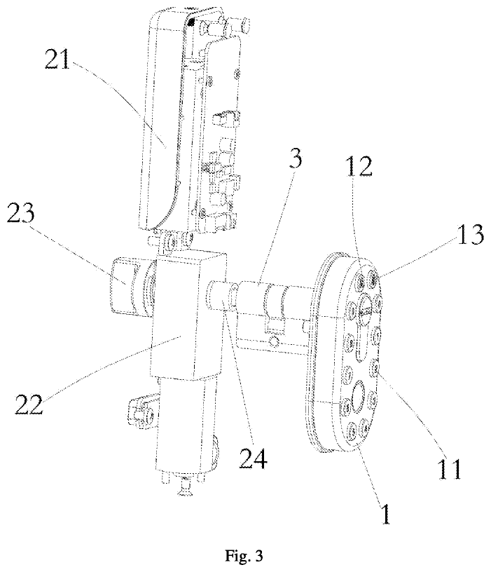

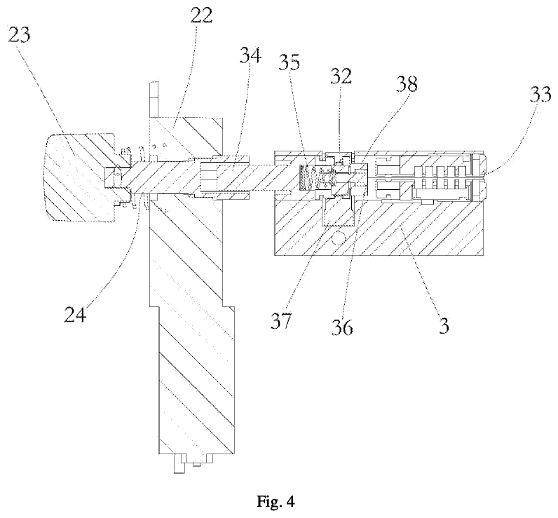

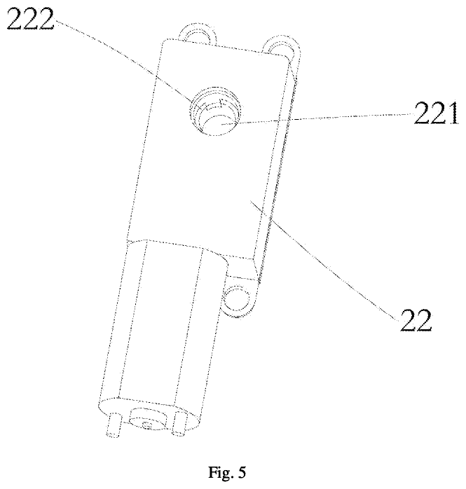

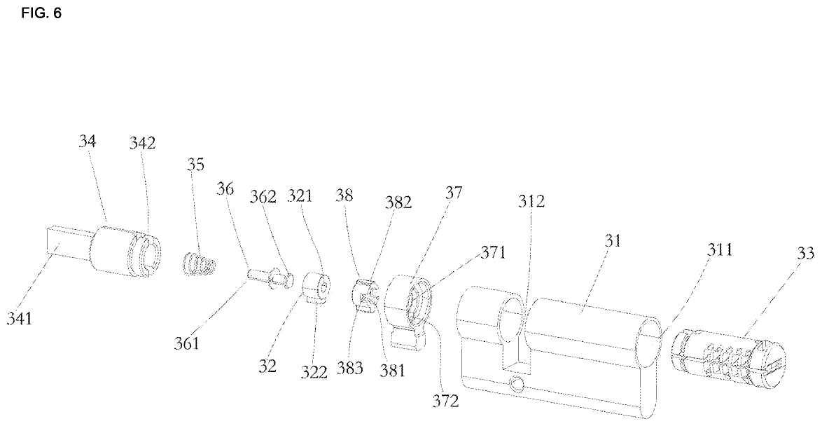

As shown in FIG. 1 to FIG. 6, a smart motor-drive mechanism for multi-point slam lock comprises an outer unit1, an inner unit 2 and an operating cylinder assembly 3 arranged between the outer unit1 and the inner unit 2, and the outer unit 1 is provided with numeral buttons 11, a locking button 12 and a bell button 13.

A battery holder 21 and a motor 22 are arranged in sequence in the inner unit 2 from top to bottom, the outer side of the inner unit 2 is provided with a thumb turn 23 matched with the motor 22 through a blade receiver 24, a lock and unlock switch 25 is arranged below the thumb turn 23 on the inner side of the inner unit 2, and the lock and unlock switch 25 is provided with an unlocking button and a locking button. A battery set is accommodated in the battery holder 21, and the battery set supplies power to the motor 22. A control mechanism is arranged in the inner unit 2, the numeral buttons 11, the locking button 12 and the lock and unlock switch 25 are connected with the control mechanism and the motor 22 in sequence so that the motor 22 can be controlled through the numeral buttons 11, the locking button 12 and the lock and unlock switch 25.

The operating cylinder assembly 3 comprises a cylinder body 31 and a cylinder drive bar assembly 34 arranged on the cylinder body 31, the cylinder body 31 is provided with a penetrating cylinder hole311, the top of the cylinder body 31 is provided with an operating cam slot 312 extending downwards from the cylinder hole311, an operating cam 37 is arranged in the operating cam slot 312, the operating cam 37 comprises a third mating hole 371 and a concave part of operating cam 372 arranged on the side wall of the third mating hole 371, a first driving head 32 and a clutch operating part 38 are arranged in sequence in the operating cam 37 from left to right, the axle center of the first driving head 32 is provided with a first mating hole 321, the outer side of the first driving head 32 is provided with a first engaging tongue 322, the axle center of the clutch operating part 38 is provided with a second mating hole 381, the side wall of the clutch operating part 38 is provided with a second engaging tongue 382, the end of the clutch operating part 38 is provided with a mating groove 383, and the outer sides of the first driving head 32 and the clutch operating part 38 are matched with the third mating hole 371. The concave part of operating cam 372 is matched with the first engaging tongue 322 or the second engaging tongue 382, so as to control the extension or retraction of the latch bolt by driving the operating cam 37 to rotate through the first driving head 32 and the clutch operating part 38.

The motor 22 is provided with a fourth mating hole 221 matched with the blade receiver 24, the inner side of the fourth mating hole 221 is provided with a driving disk 222, and the motor 22 drives the blade receiver 24 to rotate through the driving disk 222 when operating.

One side of the cylinder hole311 near the outer unit1 is provided with a key barrel 33, a slot for inserting a key is arranged in the key barrel 33, and one side of the cylinder hole311 near the inner unit 2 is provided with a cylinder drive bar assembly 34, a spring 35 and a telescopic head 36 in sequence. The spring 35 is sleeved on the telescopic head 36, the telescopic head 36 comprises a connecting shaft 361 matched with the first mating hole 321 and the second mating hole 381, and the end of the connecting shaft 361 is provided with an end cap 362.

The cylinder drive bar assembly 34 comprises a cylinder drive bar 341 and an internally hollow circular cavity 342, and the cylinder drive bar 341 is matched and connected with the blade receiver 24.

The spring 35 is arranged in the circular cavity 342, one end of the spring 35 is abutted against the side wall of the circular cavity 342, and the other end of the spring 35 is abutted against the side wall of the first driving head 32 and forces the first driving head 32 and the clutch operating part 38 to move away from the circular cavity 342.

When a door is locked, the spring 35 is extended and forces the telescopic head 36 to extend to the key barrel 33, the telescopic head 36 forces the first driving head 32 and the clutch operating part 38 to move to the key barrel 33, and at this moment, the first engaging tongue 322 of the first driving head 32 is matched with the concave part of operating cam372 of the operating cam 37. When the motor 22 is started, the motor 22 can drive the operating cam 37 to rotate when driving the first driving head 32 to rotate so that the operating cam 37 can drive the latch bolt to retract or extend.

When the door is unlocked with a key from the outside, the key is inserted into the key barrel 33 and matched with the mating groove 383 of the clutch operating part 38. When the key is pushed inwards, the key forces the telescopic head 36 to retract inwards, and the telescopic head 36 compresses the spring 35 and forces the first driving head 32 and the clutch operating part 38 to move inwards. At this moment, the first driving head 32 is separated from the operating cam 37, the clutch operating part 38 is matched with the operating cam 37, and the second engaging tongue 382 of the clutch operating part 38 is matched with the concave part of operating cam372 of the operating cam 37 so that the key can be turned to drive the operating cam 37 to rotate through the clutch operating part 38 and the operating cam 37 can drive the latch bolt to retract or extend.

The unlocking button or the locking button on the lock and unlock switch 25 can be directly pressed indoors to unlock or lock the door. Once the battery is low, the door can be unlocked by directly rotating the blade receiver 24 through the thumb turn 23. When going out, people can quickly lock the door by pressing the locking button 12 after closing the door.

The smart motor-drive mechanism for multi-point slam lock of the present invention can achieve one-click unlocking and one-click locking by arranging the motor 22 on the operating cylinder assembly and controlling the motor 22 by the button to drive the operating cam 37 to rotate so as to control the retraction or extension of the latch bolt, and is simple in structure and convenient in use. The present invention has the advantage that unlocking and locking can be realized by means of motor stalling so as to perfectly match with the lock body that is purely driven by the key to lock/unlock at different opening angles.

Finally, it should be noted that the above embodiments are only used for describing the technical solutions of the present invention rather than limitation. Although the present invention is described in detail by referring to the above embodiments, those ordinary skilled in the art should understand that the technical solution recorded in each of the above embodiments can be still amended, or some technical features therein can be replaced equivalently. However, these amendments or replacements do not enable the essence of the corresponding technical solutions to depart from the spirit and the scope of the technical solutions of various embodiments of the present invention.

1. A smart motor-drive mechanism for multi-point slam lock, comprising an outer unit, an inner unit and an operating cylinder assembly arranged between the outer unit and the inner unit, wherein the inner unit is provided with a battery holder and a motor, the outer side of the inner unit is provided with a thumb turn matched with the motor through a blade receiver, a control mechanism connected with the motor is arranged in the inner unit, the operating cylinder assembly comprises a cylinder body and a cylinder drive bar assembly arranged on the cylinder body, and the blade receiver is matched and connected with the cylinder drive bar assembly.

2. The smart motor-drive mechanism for multi-point slam lock according to claim 1, wherein the cylinder body is provided with a penetrating cylinder hole, the top of the cylinder body is provided with an operating cam slot extending downwards from the cylinder hole, an operating cam is arranged in the operating cam slot, the operating cam comprises a third mating hole and a concave part of operating cam arranged on the side wall of the third mating hole, a first driving head and a clutch operating part are arranged in sequence in the operating cam from left to right, the axle center of the first driving head is provided with a first mating hole, the outer side of the first driving head is provided with a first engaging tongue, the axle center of the clutch operating part is provided with a second mating hole, the side wall of the clutch operating part is provided with a second engaging tongue, the end of the clutch operating part is provided with a mating groove, the outer sides of the first driving head and the clutch operating part are matched with the third mating hole, and the concave part of operating cam is matched with the first engaging tongue or the second engaging tongue, so as to control the extension or retraction of the latch bolt by driving the operating camto rotate through the first driving head and the clutch operating part.

3. The smart motor-drive mechanism for multi-point slam lock according to claim 2, wherein one side of the cylinder hole near the outer unit is provided with a key barrel, a slot for inserting a key is arranged in the key barrel, and one side of the cylinder hole near the inner unit is provided with a cylinder drive bar assembly, a spring and a telescopic head in sequence; and the spring is sleeved on the telescopic head, the telescopic head comprises a connecting shaft matched with the first mating hole and the second mating hole, and the end of the connecting shaft is provided with an end cap.

4. The smart motor-drive mechanism for multi-point slam lock according to claim 3, wherein the cylinder drive bar assembly comprises a cylinder drive bar and an internally hollow circular cavity, and the cylinder drive bar is matched and connected with the blade receiver.

5. The smart motor-drive mechanism for multi-point slam lock according to claim 4, wherein the spring is arranged in the circular cavity, one end of the spring is abutted against the side wall of the circular cavity, and the other end of the spring is abutted against the side wall of the first driving head and forces the first driving head and the clutch operating part to move away from the circular cavity.

6. The smart motor-drive mechanism for multi-point slam lock according to claim 1, wherein the outer unit is provided with a numeral buttons, a locking button and a bell button.

7. The smart motor-drive mechanism for multi-point slam lock according to claim 6, wherein a lock and unlock switch is arranged below the thumb turn on the inner side of the inner unit, and the lock and unlock switch is provided with an unlocking button and a locking button.

8. The smart motor-drive mechanism for multi-point slam lock according to claim 7, wherein a battery set is accommodated in the battery holder, and the battery set supplies power to the motor; and the numeral buttons, the locking button and the lock and unlock switch are connected with the control mechanism and the motor in sequence.

9. The smart motor-drive mechanism for multi-point slam lock according to claim 1, wherein the motor is provided with a fourth mating hole matched with the blade receiver, the inner side of the fourth mating hole is provided with a driving disk, and the motor drives the blade receiver to rotate through the driving disk when operating.
